(19) United States
(12) Patent Application Publication
(10) Pub. No.: US 2012/0267256 A1
(43) Pub. Date: Oct. 25, 2012

(54) INDEPENDENT PRODUCTION OF ELECTROLYZED ACIDIC WATER AND ELECTROLYZED BASIC WATER

(75) Inventor: Douglas W. Kindred, Kennesaw, GA (US)

(73) Assignee: EAU TECHNOLOGIES, INC., Kennesaw, GA (US)

(21) Appl. No.: 13/452,327

(22) Filed: Apr. 20, 2012

Related U.S. Application Data
(60) Provisional application No. 61/477,497, filed on Apr. 20, 2011.

(51) Int. Cl. C02F 1/461; C25B 9/08

(52) U.S. Cl. 205/746; 204/275.1

(57) ABSTRACT

An apparatus for the selective production of electrolyzed water is provided, wherein the apparatus allows for the production and discharge of either electrolyzed acidic water or electrolyzed basic water to be independently without the corresponding production and discharge of the other. In certain embodiments, the present invention can provide a low chloride electrolyzed acidic water or a low chloride electrolyzed basic water.

### RELATED APPLICATIONS

This application claims priority to U.S. Prov. Pat. App. Ser. No. 61/477,497, filed on Apr. 20, 2011, which is incorporated herein by reference in its entirety.

### BACKGROUND OF THE INVENTION

1. Field of the Invention

The present invention relates generally to electrolyzed water, and more particularly to apparatus and methods for the independent production of electrolyzed acidic water and electrolyzed basic water.

2. Description of Related Art

Traditional electrolysis utilizes a brine solution. In traditional electrolysis processes, sodium ions (Na⁺) and chloride ions (Cl⁻) create hypochlorous acid (HOCl) in the anode chamber and sodium hydroxide (NaOH) in the cathode chamber. The sodium hydroxide solution, otherwise known as the electrolyzed basic water or alkaline water, commonly has a relatively high pH of 11-12, high concentration of sodium hydroxide species of approximately 200 parts per million, and a highly negative oxygen reduction potential (ORP) of about −800 mV. The high pH results in hydroxide ions (OH⁻) being the dominate species in the competition between hydroxide ions and carbonate ions in the alkaline solution. The hydroxide species will be the primary contributor to pH when the pH is 10.3 and higher, while carbonate ions will be the primary contributor to pH when the pH is 10.2 and lower. Thus, due to the high pH of the alkaline solution produced in traditional brine electrolysis, the dominate species normally is sodium hydroxide.

A variety of uses exist for both the electrolyzed acidic water and the electrolyzed basic water that are produced by electrolysis. A problem exists, however, in instances where only one of the electrolyzed water species (i.e., either acidic water or basic water) is needed, in instances wherein different amounts of the electrolyzed water species are needed, or wherein local storage facilities cannot provide sufficient capacity for one or both of the electrolyzed water species. Thus, there exists a need for the controlled production of either electrolyzed acidic water or electrolyzed basic water.

### SUMMARY OF THE INVENTION

Provided herein are methods for the selective and independent production of electrolyzed acidic water and electrolyzed basic water by electrolysis.

In one aspect, a method for producing an electrolyzed acid water stream is provided. The method includes the steps of providing an apparatus that includes an electrochemical cell having an anode, a cathode, and a membrane separating the anode and cathode, thereby providing an anode portion of the electrochemical cell and a cathode portion of the electrochemical cell. The method includes the step of supplying a feed stream that includes water and sodium chloride to the electrochemical cell and electrolyzing said feed stream to produce an electrolyzed acidic water product stream in the anode portion of the electrochemical cell and an electrolyzed basic water stream in the cathode portion of the electrochemical cell. The method includes the step of discharging at least a portion of the electrolyzed acidic water product stream from the apparatus. The method includes the step of supplying the electrolyzed basic water stream to a blending tank such that the volume of electrolyzed basic water is discharged from the apparatus is no greater than 25% of the volume of electrolyzed acidic water that is discharged from the apparatus, wherein said electrolyzed basic water is combined with the feed stream and supplied to the electrochemical cell.

In certain embodiments the method further includes the steps of supplying a portion of the electrolyzed acidic water product stream to an acid recirculation tank and supplying at least a portion of the electrolyzed acidic water from the acid recirculation tank to the electrochemical cell where said electrolyzed acidic water is combined with sodium carbonate. In other embodiments, the method can include the step wherein the sodium carbonate is supplied as an aqueous sodium carbonate stream to the acid recirculation tank. The method can also include the step wherein thee volume of electrolyzed basic water is discharged from the apparatus is no greater than 20% of the volume of electrolyzed acidic water that is discharged from the apparatus.

In an alternate aspect, a method for producing an electrolyzed basic water stream is provided. The method includes the step of providing an apparatus having an electrochemical cell comprising an anode, a cathode, and a membrane separating the anode and cathode, thereby providing an anode portion of the electrochemical cell and a cathode portion of the electrochemical cell. The method includes supplying a feed stream that includes water and sodium carbonate to the electrochemical cell and electrolyzing said feed stream to produce an electrolyzed acidic water stream in the anode portion of the electrochemical cell and an electrolyzed basic water product stream in the cathode portion of the electrochemical cell. The method further includes the step of supplying said electrolyzed acidic water stream to an acid recirculation tank, the acid recirculation tank being fluidly connected to said feed stream, wherein said electrolyzed acidic water is combined with the feed stream and supplied to the electrochemical cell. The method includes the step of collecting a product stream comprising the electrolyzed basic water.

In certain embodiments, all of the electrolyzed acidic water stream is supplied to the acid recirculation tank such that no electrolyzed acidic water is discharged from the apparatus. In certain embodiments, a portion of the electrolyzed acidic water stream from the acid recirculation tank is supplied to a sodium carbonate injector, wherein the sodium carbonate injector is coupled to a sodium carbonate tank having an aqueous sodium carbonate solution, wherein the sodium carbonate injector combines a portion of the aqueous sodium carbonate solution with the electrolyzed acidic water stream. In certain embodiments, the aqueous sodium carbonate solution is a saturated solution.

In another aspect, an apparatus suitable for the independent production of an electrolyzed acidic water stream and an electrolyzed basic water stream is provided. The apparatus includes an electrochemical cell, said electrochemical cell having an anode, a cathode, a membrane positioned between the anode and cathode, thereby providing an anode portion and cathode portion of the electrochemical cell. The electrochemical cell also includes a first input for receiving an anode feed stream to the anode portion of the electrochemical cell, a second input for receiving a cathode feed stream to the cathode portion of the electrochemical cell, an anode output for supplying an electrolyzed acidic water product stream from the anode of the electrochemical cell, and a cathode output for supplying an electrolyzed basic water product stream from the cathode of the electrochemical cell. The apparatus includes a water supply, and an acid recirculation tank, said acid recirculation tank including a first recirculation tank input for receiving a sodium carbonate containing solution, a second recirculation tank input for optionally receiving a portion of an electrolyzed acidic water product stream, a third recirculation tank input for receiving water from the water supply tank, and a recirculation tank output for supplying a feed stream comprising water and sodium carbonate to the first input of the electrochemical cell. The apparatus includes a blending tank, wherein the blending tank includes blending tank input for receiving a basic electrolyzed water product stream, a first blending tank output for supplying a portion of the basic electrolyzed water product stream to the second electrochemical cell input, and a second blending tank output for supplying an electrolyzed basic water product stream. The apparatus includes a first water supply line fluidly connected to the acid recirculation tank and a second water supply line fluidly connected to the electrochemical cell, wherein water can be selectively supplied the first and second electrochemical cell inputs. The apparatus includes a first three-way valve fluidly connecting the recirculation tank output and first blending tank output with the second water supply line, and a second three-way valve for controlling flow of the anode output to the acid recirculation tank and an acidic water bulk storage tank.

In certain embodiments, the acid recirculation tank further includes a second recirculation tank output for supplying an aqueous feed stream to a sodium carbonate tank, wherein the sodium carbonate tank is coupled to the apparatus and the tank includes a venturi injector for supplying sodium carbonate to an aqueous feed stream, said sodium carbonate tank including an outlet fluidly connected to the first recirculation tank input. In certain embodiments, the apparatus further includes a line for supplying an aqueous sodium chloride solution to the electrochemical cell.

### BRIEF DESCRIPTION OF THE DRAWINGS

FIG. 1 is a schematic of one embodiment of the present invention.

FIG. 2 is a schematic of a second embodiment of the present invention.

### DETAILED DESCRIPTION

Although the following detailed description contains many specific details for purposes of illustration, one of ordinary skill in the art will appreciate that many variations and alterations to the following details are within the scope of the invention. Accordingly, the exemplary embodiments of the invention described below are set forth without any loss of generality to, and without imposing limitations thereon, the present invention.

As used herein , the terms “electrolyzed alkaline water”, “electrolyzed base water” and “electrolyzed basic water” are used interchangeably.

As used herein , the terms “electrolyzed acid water” and “electrolyzed acidic water” are used interchangeably.

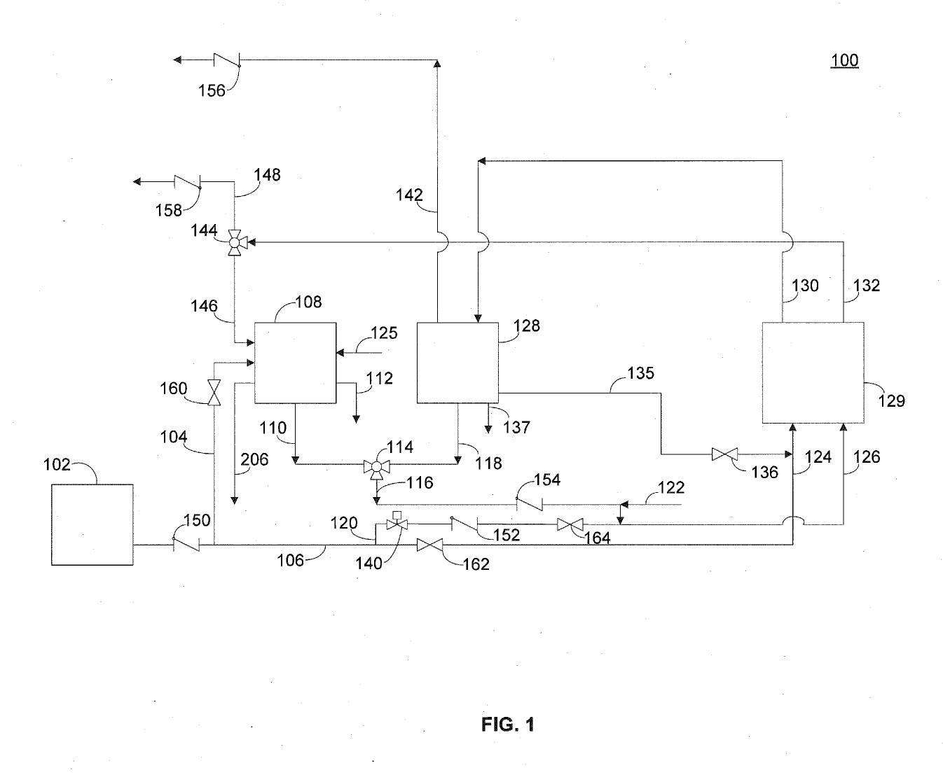

Referring to FIG. 1, apparatus 100 is provided for the independent production of electrolyzed acidic water and electrolyzed basic water according to one embodiment of the present invention. Water is supplied from water supply 102 via line 106 to a first inlet of electrochemical cell 129 for the production of electrolyzed basic water. Line 106 can include one or more valves designed to control the flow of fluids or prevent back flow of fluids within the line, such as check valve 150 and gate valve 162.

A portion of the water from line 106 can be separately supplied via line 120 to a second inlet of electrochemical cell 129 for the production of an electrolyzed acidic water. Line 120 can include one or more valves for controlling fluid flow therein, such as check valve 152, actuated or powered valve 140, and gate valve 164.

A portion of the water from water supply 102 can be supplied via line 104 to acid recirculation tank 108. In certain embodiments, water can be supplied to acid recirculation tank 108 for the initial fill. Line 104 can include one or more valves, such as gate valve 160, designed to control flow of water into acid recirculation tank 108.

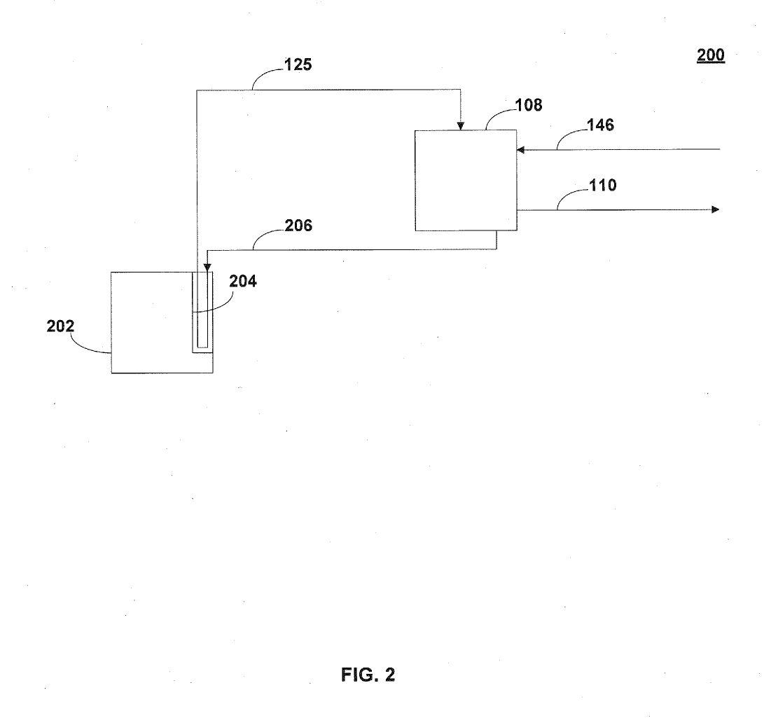

Acid recirculation tank 108 can receive electrolyzed acidic water from electrochemical cell 129 via line 146 and fresh water via line 104. Acid recirculation tank 108 can receive a supply of sodium source, such as sodium carbonate, sodium bicarbonate, sodium chloride, sodium hydroxide (dilute), or other sodium containing salt, via line 125. Typically, sodium carbonate is supplied as a solution, such that the concentration of the sodium carbonate within acid recirculation tank 108 is sufficient to provide the sodium to produce the NaOH in the basic water. Acid recirculation tank 108 can also include drain 112 or other means for the removal of excess or overflow fluids. Acid recirculation tank 108 can also include line 206 for recirculation of the tank fluids to sodium carbonate tank 202 shown in FIG. 2. It is understood that other means for supplying sodium carbonate other than the use of a storage tank can be employed, such as the direct injection of sodium carbonate or other sources of sodium via a chemical metering pump, and does not necessarily require a storage tank. In certain embodiments, sodium carbonate is preferred because it produces no chlorides in either the electrolyzed acidic water or electrolyzed basic water product streams. The use of a recirculating tank, as described herein, can help to prevent the crystallization of sodium carbonate from a concentrated solution in the supply lines by ensuring that the concentration in the lines is well below saturation for common ambient temperature.

A portion of the solution in acid recirculation tank 108 can be removed via line 110 and supplied to three-way valve 114, which controls the flow of the solution. Three-way valve 114 can be used to supply all of the solution from blend tank 128 to line 116 via line 118. Three-way valve 114 can also be used to supply all or a portion of the solution to line 120, wherein a recirculated stream of acidified water that includes sodium carbonate from recirculation tank 128 is supplied to three-way valve 114 via line 110, to produce an acid input feed to the anolyte chamber of electrochemical cell 129. Line 116 can include one or more valves, such as check valve 154. A blend/recirculation pump can be present to provide either basic electrolyzed water from blend tank 128 to the anolyte chamber inlet for pH control of the anolyte, or it can optionally serve as a recirculation pump to recirculate acid electrolyzed water and sodium carbonate in the basic water only mode, described later herein. In certain embodiments, a saturated or partially saturated saline solution can be injected into line 116 via line 122, particularly during the production of electrolyzed acidic water. In certain embodiments, the saline stream can have a sodium chloride concentration of about 150 and 400 ppm. The combined stream can have a saline concentration ranging from less than about 100 ppm, up to over 2000 ppm, although it is understood that other concentrations can be used. In certain embodiments wherein low chloride production is desired, such as to prevent corrosion in equipment, the saline stream may have a sodium chloride concentration of between about 150 and 400 ppm, generally resulting in a chloride concentration in the product stream of less than about 200 ppm, typically between about 80 and 150 ppm. It is understood that at lower concentrations of sodium chloride in the saline stream, increased power is needed for operation of the electrochemical cell. In certain embodiments, a conductivity sensor can be employed downstream of the saline injection to measure the conductivity and ensure the saline concentration is maintained at the desired level.

Electrochemical cell 129 typically includes at least one pair of electrodes, of any shape or size; preferably pairs of flat metal plates serving as the anode and cathode, which are separated by a permeable membrane. In certain embodiments, the electrochemical cell can include an ion selective membrane that allows only sodium ions to cross through the membrane, and prevents fluids from passing therethrough. Water can enter the electrochemical cell though one or more inlets, optionally located at or near the bottom of the cell, and can be directed to the respective anode and cathode metals where electrolysis occurs. The electrolyzed alkaline and acidic solutions can exit the generator cell via one or more outlets, optionally located at or near the top of the generator cell.

The anode and cathode electrodes can comprise titanium or titanium coated with a precious metal, such as platinum, or alternatively any other suitable electrode material, as known in the art. The cell electrodes preferably have a fixed surface area. The membrane can comprise either a non-ion selective separator membrane comprising, for example, non-woven polyester fabric, or an ion selective permeable membrane comprising, for example, a perfluorosulfonate ionomer. The membrane can be spaced between the electrodes by electrically insulating plastic spacers. The electrodes can be connected to a conventional electrical power supply.

Electrochemical cell 129 can include two inlets, a first inlet for receiving water supplied via line 106 and then line 124, for the production of electrolyzed basic water and a second inlet for receiving water and/or basic electrolyzed solution from acid blend tank 108 supplied via line 126 for the production of electrolyzed acidic water at an elevated pH when desired. Electrochemical cell 129 can include two outlet lines, a first outlet supplying line 130 that can be used to convey electrolyzed base water from electrochemical cell 129 and a second outlet supplying line 132 that can be used to convey electrolyzed acid water from the electrochemical cell.

Line 130, which conveys electrolyzed base water from electrochemical cell 129, supplies the electrolyzed base water to blend tank 128. Lines 130 and 142 can each include one or more valves, such as check valve 156. Electrolyzed basic water entering blend tank 128 can flow through output line 142, which can be used to supply electrolyzed basic water stream to the basic electrolyzed water bulk storage tank, or through line 118 through valve 114 and into line 116. Portions of the basic water stream supplied by line 118 can be added to the supply water in line 120 to increase the pH of the acidic electrolyzed water to the desired pH level.

Line 132, which conveys electrolyzed acidic water from electrochemical cell 129, supplies the electrolyzed acidic water to three-way valve 144, which can be used to direct the electrolyzed acidic water to either acid recirculation tank 108, where the electrolyzed acidic water can optionally be combined with sodium carbonate from line 125 and/or diluted with water from line 104, and/or to provide an electrolyzed acidic water product stream via line 148. Lines 132, 146, and 148 can optionally include one or more valves, such as check valve 158, which is located in line 148.

With reference to apparatus 100, while certain valves are shown and identified, such as certain gate valves and check valves, it is understood that the specific valves identified and shown are intended to be exemplary, and that in certain embodiments other valves may be used in place or, or in addition to, the valves shown in the figure, such as for example, ball valves, butterfly valves, relief valves, and the like. In certain embodiments, one or more of the three-way valves utilized in apparatus 100 can be pneumatically operated. In certain embodiments, any means to control the flow of fluids within the apparatus can be employed, including the use of automated means though the use of a computer and multiple sensors and valves. While automated controls are preferred in certain embodiments, manually controlled valves are also within the scope of the invention. Additionally, as may be necessary, apparatus 100 can include one or more pumps positioned to supply various fluids throughout the system. For example, in certain embodiments, apparatus 100 can include a pump proximate to and downstream from water supply 102. In other embodiments, lines 116 can include a pump for supplying fluids to electrochemical cell 129. In certain preferred embodiments, a blend pump is positioned in line 116.

In certain embodiments, acid recirculation tank 108 and blend tank 128 can include indicators and/or sensors that are operable to detect levels of fluids in the tanks and, in certain embodiments, indicate or provide an electronic signal to a coupled control device when a particular low level of fluids within one or both of the tanks. In certain embodiments, the apparatus can include various probes, such as a pH probe, an oxidation reduction potential (ORP) probe, a conductivity probe, or a monitor for determining the HOCl concentration. For example, line 132 can include one or more of a pH probe, an ORP probe, or an HOCl monitor. One of skill in the art would understand that various probes can be positioned within any of the lines or tanks of apparatus 100, and that said probes can be electronically coupled to a computer or like device for automated control of the apparatus.

In certain embodiments, one or more of the lines can include a flow meter. For example, in certain embodiments, one or more of lines 106 and/or 126 can include a flow meter to measure and control the flow of fluids therethrough. In certain embodiments, one or more lines within apparatus 100 can include a mixing device, which can be operable to provide mixing of various streams being supplied thereto. For example, in certain embodiments, line 106 can include an in-line mixer. In certain embodiments, the mixing device may be preferably placed within a line downstream from a location where the contents of one or more lines are combined.

In certain embodiments, apparatus 100 can include one or more heating device(s) or heat exchanger(s). In certain embodiments, apparatus 100 may include one or more filtration device(s).

In certain embodiments, a portion of the alkaline water supplied via line 118 can be combined with saline stream supplied via line 122 and supplied to electrochemical cell 129 via inlet 126 for the production of electrolyzed acid water.

In operation, line 130 can supply an electrolyzed basic water product stream from eletrochemical cell 129 that has a pH of greater than about 10, alternatively greater than about 11, or alternatively between about 11 and 13, alternatively between about 11.5 and 12.5. In certain embodiments, the electrolyzed basic water product stream can include no chlorides.

In operation, line 132 can supply an electrolyzed acidic water product stream that has a pH of less than about 6.5, alternatively less than about 5.5, alternatively less than about 5, alternatively less than about 4.5, alternatively between about 3 and 5, or alternatively between about 3.5 and 4.5. In certain embodiments, the pH of the electrolyzed acidic water product stream may be between 1.5 and 2, alternatively between about 2 and 2.5, alternatively between about 2.5 and 3, alternatively between about 3 and 3.5. The ORP of the electrolyzed acidic water product stream supplied via line 148 can be greater than about 1100 mV, alternatively greater than about 800 mV. The electrolyzed acidic water product stream supplied via line 148 can have an HOCl concentration of up to about 300 ppm, or greater, alternatively less than about 75 ppm, alternatively less than about 50 ppm, alternatively between about 10 and 50 ppm, or alternatively between about 20 and 45 ppm.

In certain embodiments, all or a portion of the electrolyzed acidic water from line 132 can be supplied to acid recirculation tank 108 via 3-way valve 144 and line 146. Alternatively, all or a portion of the electrolyzed acidic water from line 132 can be supplied to a storage tank (not shown) or alternative process via 3-way valve 144 and line 148.

According to one embodiment of the invention, a single electrochemical cell can be operated in two different modes to produce either an electrolyzed acidic water only (referred to herein as the “first mode” or the “acid water only mode”), or in a second mode wherein only an electrolyzed basic water is produced (referred to herein as the “second mode” or the “basic water only mode”). In certain embodiments, it is possible to produce and discharge an electrolyzed acid water stream, and a relatively small amount of electrolyzed basic water. These modes can be operated such that when the apparatus is in acid water only mode, no basic water is discharged from the apparatus. Similarly, when the apparatus is in basic water only mode, no acid water is discharged from the apparatus. In certain embodiments, two cells can be set up proximate to each other and each can be operated to produce and discharge either the acidic water or the basic water, such that the combination of the two reactors produces and discharges both streams. In certain embodiments of the present invention, the apparatus can be operated to selectively produce and discharge either the electrolyzed acidic water or the electrolyzed basic water utilizing only one electrochemical cell and one power supply, thus reducing the size and energy requirements of the system, as well as the complexity and capital cost of the system. In certain embodiments, multiple electrochemical cells and multiple power sources can be operated depending upon the needs of the user in terms of types and volumes of water produced and discharged.

As noted previously, in the first mode only electrolyzed acidic water is produced. In the first mode, up to about 85% of any electrolyzed basic water that is produced can be utilized to increase the pH of the electrolyzed acidic water to approximately 4 by supplying the basic water to blend tank 128 via line 130. The amount of water recycled can vary, depending upon the desired pH of the acid water product stream. Combining a portion of the electrolyzed basic water and raising the pH of the feed to cell 129 eliminates chlorine gas odors and provides 100% HOCl in the acid water. If the electrolyzed basic water is not blended with the electrolyzed acid water, a much lower pH of the electrolyzed acidic water of about 2.5 or lower can be obtained and about 20% or more of the chlorine that is produced will be in the form of chlorine gas, rather than HOCl. The resulting electrolyzed acidic water will have a distinctive chlorine smell.

Typically, when the apparatus is running in the first mode (i.e., the apparatus is producing and discharging electrolyzed acidic water only), only a small amount of the electrolyzed basic water is available to be supplied to the end user's electrolyzed basic water bulk storage tank via line 142. The amount of electrolyzed basic water that can be supplied to the basic water bulk storage tank can be up to about 20% by volume of the flow of the electrolyzed acidic water to the acidic electrolyzed bulk storage tank, alternatively between about 15 and 20% of the flow of the electrolyzed acidic water, alternatively between about 10 and 15%, alternatively between about 5 and 10%. The amount of basic water available will depend on the desired pH of the acidic electrolyzed water that is discharged.

In the acid water discharge only mode, sodium chloride is added to the anode side of the electrochemical cell as the chloride source for HOCl in the electrolyzed alkaline water. Sodium carbonate is not added when the apparatus is being operated in an electrolyzed acid water only mode. In the acid water discharge only mode, the sodium chloride is continuously added the acid side of the cell. The alkaline recirculation stream is supplied with electrolyzed basic water from electrochemical cell 129, supplied via line 130 to blend tank 128, which then supplies the electrochemical cell via line 135. Line 135 can include a valve, shown as 136.

During the acid water discharge only mode, some electrolyzed basic water is produced and must be discharged (as a bleed stream) via line 137 to prevent the pH of the alkaline recirculation stream, wherein a majority of the alkaline water produced by electrochemical cell 129 is supplied to blend tank 128 and recirculated as a feed stream back to the electrochemical cell. A relatively small portion of the alkaline water can be discharged via line 142 as a high purity sodium hydroxide stream, which can be utilized in an alternate process or sold. The stream can have a pH of about 13 or greater and a concentration of about 30% or greater, alternatively at least about 40%, and in certain embodiments, up to about 50%. It is understood that the bleed stream volume can be increased to decrease the concentration and pH of the base water being discharged. For example, in certain embodiments, by doubling the volume of the bleed stream, the concentration of sodium hydroxide of the bleed stream is reduced by 50%.

Many clean in place (hereinafter, “CIP”) systems and other sanitation applications require large volumes of both electrolyzed basic water and electrolyzed acidic water. Typically, an electrochemical cell that is configured to produce and discharge an acid water product stream having a pH range of between about 4 and 5 or greater will generally have relatively low flow rates of alkaline water to a bulk storage tank, typically producing 4-5 times greater volumes of the electrolyzed acidic water than the electrolyzed basic water. This results in the basic water bulk storage tank have a lower volume than the corresponding acidic water bulk storage tank. The system can include sensors that monitor the fluid levels in the bulk acidic water and bulk basic water storage tanks. When the sensor senses that the fluid level in the bulk basic water storage tank is low, then the system can switch to the basic water only mode, wherein only basic water is produced and discharged to the storage tank, thereby allowing for the fluid levels of the bulk storage tanks to be adjusted. Such sensors are known in the art and can be configured in the manner specified.

In prior art electrochemical cells, the electrochemical cell simultaneously produces both the electrolyzed acidic water and electrolyzed basic water, and the cell must be operated if either fluid (i.e., the acidic or basic water) tank is low. This results in the waste of large amounts of water as the full tank will overflow while the cell operates to produce fluids to supply to the tank with the low level. Any electrochemical cell having a fixed production ratio of acidic to basic electrolyzed water will result in some portion of the water being wasted as real world consumption will not match the fixed production ratio. By being able to independently produce and discharge either the acidic or basic electrolyzed water, certain embodiments of the present invention eliminate this problem, eliminating any wasted water. In the basic water only mode, the apparatus discharges no acid water, thus allowing the basic water bulk storage tank to be refilled even if the acidic water bulk storage tank is full. No acid water is wasted in this mode. In certain embodiments, the electrochemical cell described herein allows for the user to selectively produce desired quantities of electrolyzed acidic water and electrolyzed basic water, without sacrificing desired fluid properties, such as pH, ORP, or the concentration of HOCl and/or NaOH.

The basic water only mode is accomplished by positioning three valves, valves 114, 140 and 144, such that a recirculating loop is created on the acid side of the cell. The valves can be manual, pneumatic, electric, or the like. In basic water only mode, valve 114 is positioned such that the flow from acid recirculation tank 108 is supplied completely to line 116. Similarly, valve 144 is positioned such that all acid produced by electrochemical cell 129 is recirculated to acid recirculation tank 108, with no flow being supplied to acid water product stream line 148. All of the electrolyzed basic water produced by electrochemical cell 129 and carried in line 130 is supplied to basic water product stream 142.

In basic water only mode, a source of sodium, such as sodium carbonate, is supplied to this recirculating acid water loop. The sodium is supplied to electrochemical cell 129 and crosses over to the catholyte side to produce NaOH, the main ingredient that produces the high alkalinity of the electrolyzed basic water. As noted previously, the pH of the electrolyzed basic water is greater than about 10, and in certain embodiments ranges from about 11.5 to 13, or in alternate embodiments from 12 to 13.5.

In certain embodiments, NaCl can be used as the sodium source in the basic water only mode, however, the chlorides that are produced have no place to go and the loop will begin produce chlorine gas. The gas can be dissolved in water and removed from the system as a weak bleach solution. In certain embodiments, it can be preferable to use Na₂CO₃ as the sodium source. Other possible sodium sources can include sodium bicarbonate, or very small amounts of NaOH. Typically, NaOH is avoided for use as a source of sodium as at commercial concentrations of 30% to 50%, it is very dangerous, and does not meet the requirements for a “green” process. Certain commercial plants now operating use concentrated NaOH, and the use of NaOH concentrate is often a major cause of lost time, injuries, and accidents in certain plants.

In certain embodiments, a pump is employed to circulate fluids through apparatus 100. For example, line 116 can include a pump, which in base water only mode (wherein only electrolyzed basic water is discharged from the apparatus) can be used to recirculate the electrolyzed acid water from acid blending tank 108 to electrochemical cell 129. In alternate embodiments, such as during the production of electrolyzed acidic water, the speed of the pump within line 116 can be varied to control the pH of the acidic water that is produced by electrochemical cell 129. In certain embodiments, a sensor can be utilized to determine the pH of the acidic water exiting the electrochemical cell 129, and the sensor can be electronically coupled to the pump in line 116, thereby allowing the pH of the acidic water to be controlled by the pump speed.

In certain embodiments, the conductivity of fluids within the recirculating acid loop can be monitored, for example, by positioning a sensor within line 132. The conductivity of the acidic water correlates to the sodium carbonate concentration. By monitoring the conductivity of the electrolyzed acidic water in line 132, it can be determined when it is necessary to add sodium carbonate, or an alternate sodium source, to acid recirculation tank 108 to ensure that enough sodium is present such that NaOH is produced and the pH of the electrolyzed basic water is maintained within a desired range.

When the system operates in a basic water only discharge mode, in certain embodiments, the sole source of sodium that is supplied to the system is Na₂CO₃. In this mode, NaCl is not added to the system. In contrast, when the system is operating in an acidic water only discharge mode, the sodium source is typically saline (NaCl) addition at line 122. In general, during the production of electrolyzed acidic water, Na₂CO₃ is not added to the system, and in certain embodiments NaCl can be the only source of sodium that is supplied to the apparatus.

During normal operating modes, wherein both electrolyzed acidic water and electrolyzed basic water are being produced and discharged, the acid recirculation tank is isolated from the system. When the valves are positioned to operate in a basic water only discharge mode, at least a portion of the acidic water in the acid recirculation tank is recirculated to electrochemical cell 129 with the use of a blend pump. The conductivity of the acid recirculation solution in line 110 can be measured to determine if additional sodium carbonate should be added to the fluids in acid recirculation tank. In general, the conductivity of the acid recirculation solution in line 110 is maintained at between about 2,500 and 13,000 microsiemens (μS), alternatively between about 5,000 and 10,000 microsiemens (μS).

The sodium carbonate can be mixed in lean mixtures that remain in suspension at room temperature, however this procedure can require that the operator measure and mix reagents. In certain embodiments, a large amount of sodium carbonate can be added to a sodium carbonate supply tank that is kept at about a saturated or super-saturated concentration, and which can be prepared such that it does not require highly accurate measuring by the operator. By loading the sodium carbonate supply tank at a higher concentration, this allows the tank to be left unattended for extended periods of time, such as up to a week at a time, or longer. Generally, it is desirable to prevent crystallization of sodium carbonate within the lines that transport the sodium carbonate solution from the sodium carbonate supply tank to the acid recirculation tank. In certain embodiments, the sodium carbonate supply tank can include means for mixing the sodium carbonate.

Referring to FIG. 2, an apparatus 200 and method for providing a saturated sodium carbonate stream is provided. Apparatus 200 is configured to store a high concentration sodium carbonate solution, which in certain embodiments can be maintained at a saturated or near-saturated concentration. Apparatus 200 can be used to transport the sodium carbonate solution and eliminates the crystallization of sodium carbonate within the lines between the sodium carbonate supply tank and the acid recirculation to acid holding tank 108, which has a lower sodium carbonate concentration. Apparatus 200 can include a pump, such as a magnetic drive centrifugal pump, to power a separate sodium carbonate recirculating loop from acid recirculation tank 108, through a venturi injector that can be located within pipe 204, such as a T-style venturi eductor, which can be submerged or partially submerged in sodium carbonate tank 202, and back to the acid recirculation tank via line 125. One advantage of apparatus 200 is that the venturi injector is submerged in sodium carbonate tank 202 and is thus maintained at a temperature that is close to the temperature of the water within the sodium carbonate tank. Once the sodium carbonate concentrate enters the venturi injector, it is immediately diluted by the fluids in line 206, such that sodium carbonate concentration in the loop is less than about 1%. By immediately diluting the sodium carbonate fluids, this maintains a low enough sodium carbonate concentration in line 125 to ensure there is no crystallization of sodium carbonate within the lines, thus eliminating the need for providing separate heating means or undertaking other measures designed to eliminate crystallization. In certain embodiments, conductivity sensors can be positioned in the acidic water product stream line (such as line 132) to determine when additional sodium carbonate needs to be added to the acid stream.

In certain embodiments, it may be desired to store sodium carbonate in sodium carbonate tank 202 such that no mixing of the sodium carbonate and water is required from operators of the apparatus, and that there is a sufficient quantity of sodium carbonate in the tank to allow operation for a week or more before requiring the addition of more sodium carbonate. In certain embodiments, this can be accomplished with the use of common chemical injection pumps, however crystallization in the sodium carbonate can readily occur, for example in line 125, unless heat tracing or other special measures are utilized. It is well known that sodium carbonate can readily precipitate from solution upon rapid, but not necessarily large, temperature change. The use of venture type injection device 204, as described herein, can provide a simple method to ensure that the sodium carbonate is transferred to the acid recirculation tank as required to replace sodium ions that cross the membrane to form sodium hydoxide when the apparatus is operated in an alkaline electrolyzed water only mode. The venturi mixes the saturated sodium carbonate solution in tank 202 with the acidic water in the carbonate transport lines 206 and 125 such that it is maintained a concentration that is well below saturation, thus eliminating concerns about crystallization in the lines and eliminating the need for any heat tracing of the lines. The use of the venture injection system also allows the sodium carbonate tank to be super saturated to provide long run times before additional sodium carbonate is added to the tank. In certain embodiments, the sodium carbonate tank can include means for periodically mixing or circulating the solution to maintain the solution at or near the point of saturation.

The supply of sodium carbonate to acid recirculation tank 108 from sodium carbonate tank 202 via line 125 can be cycled often as needed to maintain a desired conductivity of the solution in the acid recirculation tank between a low and a high conductivity set point. In certain embodiments, a conductivity of between about 5,000 micro Siemens (μS) and 10,000 micro Siemens (μS) is desired. A rectifier can be connected to electrochemical cell 129 to automatically control the voltage of the electrochemical cell to maintain a fixed current flow to the cell, even though the conductivity of the acid water being supplied to the electrochemical cell may vary slightly as the concentration of sodium carbonate supplied from carbonate tank 202 may vary. In certain embodiments, the electrochemical cell rectifier can be coupled to a control unit, which can also be connected to one or more conductivity sensor(s), and/or pH sensor(s).

In certain embodiments, system 100 can include one or more sensors that are operable to determine fluid levels in the electrolyzed acid water and electrolyzed base water bulk storage tanks that may be located downstream from lines 148 and 142, respectively. Operation of the system between the acid only discharge and base only discharge modes can be done manually by an operator, or this process can be automated by having the system monitor the levels in the electrolyzed acid water and electrolyzed base water bulk storage tanks and controlling the production of the electrolyzed acid and base waters based upon the levels detected.

In certain embodiments, during operation of the cell, a electrolyzed basic water product stream can be produced and discharged from the apparatus, without any corresponding production of chlorides. Current electrochemical cells typically require the addition of a salt, such as NaCl, to both sides of the cell (i.e., to both the cathode and anode sides of the electrochemical cell). This results in production of chlorides in the alkaline water product stream, which in turn can lead to corrosion of some metals in equipment that is cleaned with or comes in contact with the electrolyzed basic water. For example, in certain instances, electrolyzed basic water can be used to clean food preparation equipment. Prior art electrochemical cells that utilize sodium chloride as the sodium source produce an electrolyzed basic water product stream that includes residual chlorides, which can then be used to clean and/or sterilize food preparation equipment. In some applications, the basic water must be heated. The presence of chlorides in the basic water and the addition and elevated temperatures can result in some corrosion potential. In contrast, the present invention does not employ a saline solution that is supplied to the alkaline side of the electrochemical cell.

In certain embodiments, the present invention provides very low chloride levels in the preparation of electrolyzed acidic water. Typically, the chloride levels are less than about 200 ppm, alternatively less than about 120 ppm, and preferably less than about 80 ppm. The chloride level in the acidic water can be controlled to very low concentrations by reducing the amount of salt that is supplied to the electrochemical cell and increasing the power to the cell, thereby enabling a lower number of chloride ions available to be converted to HOCl. The amount of salt required for the a low chloride electrochemical cell is typically less than about 20% of that consumed by prior art systems, frequently less than about 10% of that consumed by prior art systems.

While the acidic water discharge only mode and basic water discharge only mode are described as being two separate modes, it is understood and within the scope of the invention that in certain embodiments, the end user may use the system to produce a first stream that includes either the acidic or basic electrolyzed water, followed by the production of a second stream that includes the other electrolyzed water, such that the same system is being used to produce both electrolyzed waters.

As is understood in the art, not all equipment or apparatuses are shown in the figures. For example, one of skill in the art would recognize that various recirculation tanks and/or pumps may be employed in the present method.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

As used herein, recitation of the term about and approximately with respect to a range of values should be interpreted to include both the upper and lower end of the recited range.

Throughout this application, where patents or publications are referenced, the disclosures of these references in their entireties are intended to be incorporated by reference into this application, in order to more fully describe the state of the art to which the invention pertains, except when these reference contradict the statements made herein.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

That which is claimed is:

1. A method for producing an electrolyzed acid water stream, the method comprising the steps of:
providing an apparatus comprising an electrochemical cell comprising an anode, a cathode, and a membrane separating the anode and cathode thereby providing an anode portion of the electrochemical cell and a cathode portion of the electrochemical cell;
supplying a feed stream comprising water and sodium chloride to the electrochemical cell and electrolyzing said feed stream to produce an electrolyzed acidic water product stream in the anode portion of the electrochemical cell and an electrolyzed basic water stream in the cathode portion of the electrochemical cell;
discharging at least a portion of the electrolyzed acidic water product stream from the apparatus; and
supplying the electrolyzed basic water stream to a blending tank such that the volume of electrolyzed basic water is discharged from the apparatus is no greater than 25% of the volume of electrolyzed acidic water that is discharged from the apparatus, wherein said electrolyzed basic water is combined with the feed stream and supplied to the electrochemical cell.

2. The method of claim 1, further comprising the steps of:
supplying a portion of the electrolyzed acidic water product stream to an acid recirculation tank; and
supplying at least a portion of the electrolyzed acidic water from the acid recirculation tank to the electrochemical cell where said electrolyzed acidic water is combined with sodium carbonate.

3. The method of claim 2, wherein the sodium carbonate is supplied as an aqueous sodium carbonate stream to the acid recirculation tank.

4. The method of claim 1, wherein the volume of electrolyzed basic water is discharged from the apparatus is no greater than about 20% of the volume of electrolyzed acidic water that is discharged from the apparatus

5. A method for producing an electrolyzed basic water stream, the method comprising the steps of:
providing an apparatus comprising an electrochemical cell comprising an anode, a cathode, and a membrane separating the anode and cathode thereby providing an anode portion of the electrochemical cell and a cathode portion of the electrochemical cell;
supplying a feed stream comprising water and sodium carbonate to the electrochemical cell and electrolyzing said feed stream to produce an electrolyzed acidic water stream in the anode portion of the electrochemical cell and an electrolyzed basic water product stream in the cathode portion of the electrochemical cell; and
supplying said electrolyzed acidic water stream to an acid recirculation tank, said acid recirculation tank being fluidly connected to said feed stream, wherein said electrolyzed acidic water is combined with the feed stream and supplied to the electrochemical cell; and
collecting a product stream comprising the electrolyzed basic water.

6. The method of claim 5 wherein all of the electrolyzed acidic water stream is supplied to the acid recirculation tank such that no electrolyzed acidic water is discharged from the apparatus.

7. The method of claim 5 wherein a portion of the electrolyzed acidic water stream from the acid recirculation tank is supplied to a sodium carbonate injector, said sodium carbonate injector being coupled to a sodium carbonate tank comprising an aqueous sodium carbonate solution, wherein the sodium carbonate injector combines a portion of the aqueous sodium carbonate solution with the electrolyzed acidic water stream.

8. An apparatus suitable for the independent production of an electrolyzed acidic water stream and an electrolyzed basic water stream, the apparatus comprising:
an electrochemical cell, said electrochemical cell comprising an anode, a cathode, a membrane positioned between the anode and cathode thereby providing an anode portion and cathode portion of the electrochemical cell, a first input for receiving an anode feed stream to the anode portion of the electrochemical cell, a second input for receiving a cathode feed stream to the cathode portion of the electrochemical cell, an anode output for supplying an electrolyzed acidic water product stream from the anode of the electrochemical cell, and a cathode output for supplying an electrolyzed basic water product stream from the cathode of the electrochemical cell;
a water supply tank;
an acid recirculation tank, said acid recirculation tank comprising a first recirculation tank input for receiving a sodium carbonate containing solution, a second recirculation tank input for optionally receiving a portion of an electrolyzed acidic water product stream, a third recirculation tank input for receiving water from the water supply tank, and a recirculation tank output for supplying a feed stream comprising water and sodium carbonate to the first input of the electrochemical cell;
a blending tank, said blending tank comprising blending tank input for receiving a basic electrolyzed water product stream, a first blending tank output for supplying a portion of the basic electrolyzed water product stream to the second electrochemical cell input, and a second blending tank output for supplying an electrolyzed basic water product stream;
a first water supply line fluidly connected to the acid recirculation tank;
a second water supply line fluidly connected to the electrochemical cell, wherein water can be selectively supplied the first and second electrochemical cell inputs;
a first three-way valve fluidly connecting the recirculation tank output and first blending tank output with the second water supply line; and
a second three-way valve for controlling flow of the anode output to the acid recirculation tank and an acidic water bulk storage tank.

9. The apparatus of claim 8 wherein the acid recirculation tank further comprises a second recirculation tank output for supplying an aqueous feed stream to a sodium carbonate tank, said sodium carbonate tank being coupled to the apparatus and comprising a venturi injector for supplying sodium carbonate to an aqueous feed stream, said sodium carbonate tank including an outlet fluidly connected to the first recirculation tank input.

10. The apparatus of claim 8 further comprising a line for supplying an aqueous sodium chloride solution to the electrochemical cell.
